(19) United States
(12) Patent Application Publication
(10) Pub. No.: US 2014/0364198 A1
(43) Pub. Date: Dec. 11, 2014

(54) Direct-Correlation Entry Based Sweepstakes

(71) Applicants: Lonnie G. Pope, Gainesville, GA (US); Christopher S. Fellows, Dacula, GA (US); Michael Ray Moore, Morris, AL (US)

(72) Inventors: Lonnie G. Pope, Gainesville, GA (US); Christopher S. Fellows, Dacula, GA (US); Michael Ray Moore, Morris, AL (US)

(21) Appl. No.: 13/913,638

(22) Filed: Jun. 10, 2013

Related U.S. Application Data
(60) Provisional application No. 61/832,472, filed on Jun. 7, 2013.

(51) Int. Cl. G07F 17/32

(52) U.S. Cl. CPC G07F 17/329
USPC 463/25

(57) ABSTRACT

A system and method of providing a sweepstakes associated with a commercial application including generating a series of sweepstakes tickets, each ticket having a par value and is assigned a prize value, wherein the sum of the par values of the series of sweepstakes tickets is equal to the sum of the prize values of the sweepstakes tickets, assigning one or more sweepstakes tickets to a user, determining the value of the one or more sweepstakes tickets assigned to the user, and notifying, using a display, the user of the value of the one or more sweepstakes tickets assigned to the user.

### TECHNICAL FIELD OF THE DISCLOSURE

The present disclosure relates to promotional methods for goods and/or services and, more particularly, relates to a method for tying goods and/or services to a sweepstakes to facilitate patronage of said goods and/or services.

### BACKGROUND OF THE DISCLOSURE

As a promotional tool, sweepstakes and/or sweepstakes games are often associated with the purchase of good or services. For example, purchase of a product may entitle a user to entry into a contest to win a prize. Further, due to applicable federal and state laws, entries into such sweepstakes may be acquired via a request for a free entry into the sweepstakes.

Sweepstakes may often be used in e-commerce applications to drive traffic to a website. It is very possible for e-commerce websites to make less than its costs of operation or to turn an insufficient profit if there is not enough traffic to its website. Thusly, it is important for such systems to be publicized and attractive to consumers. As they currently stand, however, it sometimes can be difficult to differentiate one website over another in a similar area of commerce due to the similarities in offerings and methods of operations.

Some sweepstakes systems and methods involve presenting the sweepstakes in a manner which provides entertainment or amusement for the user. Such methods may include pairing the products or services with an entertaining sweepstakes. For example, a user on a website may see the products or services for purchase on one side of his/her screen and a sweepstakes in the form of, for example, a casino game next to the products or services. Some such example methods can be seen in U.S. patent application Ser. No. 13/682,168, “Penny Auction Sweepstakes.”

However, recent court decisions in the United States have ruled unfavorably against sweepstakes that have an entertaining display, such as a game environment. As such, a need exists for sweepstakes systems and methods having a non-entertaining display.

The present disclosure is directed to systems and methods that address one or more of the problems set forth above. However, it should be appreciated that the solution of any particular problem is not a limitation on the scope of the disclosure or of the attached claims except to the extent expressly noted. Additionally, the inclusion of any problem or solution in this Background section is not an indication that the problem or solution represents known prior art except as otherwise expressly stated.

### SUMMARY OF THE DISCLOSURE

In accordance with one aspect of the present disclosure, a method is provided for providing a sweepstakes associated with a commercial application including generating a series of sweepstakes tickets, each ticket having a par value and is assigned a prize value, wherein the sum of the par values of the series of sweepstakes tickets is equal to the sum of the prize values of the sweepstakes tickets, assigning one or more sweepstakes tickets to a user, determining the value of the one or more sweepstakes tickets assigned to the user, and notifying, using a display, the user of the value of the one or more sweepstakes tickets assigned to the user.

In accordance with another embodiment, a nontransitory computer readable medium is provided having thereon instructions for providing a sweepstakes associated with a commercial application including generating a series of sweepstakes tickets, each ticket having a par value and is assigned a prize value, wherein the sum of the par values of the series of sweepstakes tickets is equal to the sum of the prize values of the sweepstakes tickets, assigning one or more sweepstakes tickets to a user, determining the value of the one or more sweepstakes tickets assigned to the user, and notifying, using a display, the user of the value of the one or more sweepstakes tickets assigned to the user.

Other features and advantages of the disclosed systems and principles will become apparent from reading the following detailed disclosure in conjunction with the included drawing figures.

### BRIEF DESCRIPTION OF THE DRAWINGS

FIG. 1 is flowchart showing a process for a sweepstakes in accordance with an embodiment of the invention;

FIG. 2 is a display view of terminals presenting a sweepstakes in accordance with an embodiment of the invention;

FIG. 3 is a display view of terminals presenting a sweepstakes in accordance with an alternative embodiment of the invention;

FIG. 4 is a schematic network diagram showing a network configuration in accordance with an embodiment of the invention;

FIG. 5 is a schematic network diagram showing an alternative network configuration in accordance with an embodiment of the invention;

FIG. 6 is a schematic network diagram showing a further alternative network configuration in accordance with an embodiment of the invention;

FIG. 7 is a schematic network diagram showing yet another network configuration in accordance with an embodiment of the invention;

FIG. 8 is a schematic network diagram showing another network configuration in accordance with an embodiment of the invention; and

FIG. 9 is a block diagram of an example processing system that may execute machine readable instructions of the invention.

### DETAILED DESCRIPTION OF THE DISCLOSURE

The present disclosure provides a system and method for a sweepstakes, particularly, a sweepstakes based on a direct correlation of prize amounts to the number of entries in the sweepstakes. A sweepstakes, as defined herein, is a promotion event wherein a customer receives entry (a “ticket”) to the sweepstakes via purchase and/or via non-purchase means and the ticket either wins a prize from the sweepstakes or does not win a prize. The sweepstakes and/or purchasing may be executed on one or more computing devices, for example, a personal computer, a public console site, a smart phone, a laptop computer, etc.

In some example sweepstakes, the sweepstakes may be based on a direct correlation of entries in a sweepstakes to a specific, finite number of results. Such sweepstakes may involve a process to draw or select display results, whether they are winning or losing results, for the participants in a sweepstakes. In such a system, there are a number of digital value holders (“tickets”), wherein each ticket represents only one result. There can be any number of tickets stored and catalogued in an electronic database or some other electronic or mechanical storage device.

The tickets can be generated by using a computing device or some other production method, electronic and/or mechanical, and, even though they are in a specific sequence, they are also assigned random values or no value at all. The tickets that are generated can each have a par value of $0.01, for example, but the actual value of the prize, or lack thereof, for each ticket can vary; each ticket has only one result or value. For example, if there are 1,000,000 tickets, there are 1,000,000 results, even though a vast number of the tickets will contain a 0.00 cent value. The par value of each ticket can be any amount and is not limited to being a par value of $0.01.

In one example sweepstakes, there are 1,000,000 tickets, each ticket having a par value of $0.01; therefore, the total worth of all the tickets, and thusly the sweepstakes, would be $10,000. This total amount would then be distributed among all 1,000,000 tickets but in an uneven fashion. A large number of the tickets would have an actual value of $0.00 while a few would have a value of, say, $1.00. If the operator chose $1.00 to be the highest mount to be indicated on the ticket, then the participant receiving the ticket would receive a ticket with a value from 0.00 cents to $1.00 inclusively. If the operator chose an amount for the highest value to be won as $10,000, only one ticket would be a winner and the other 999,999 would have a value of $0.00.

As such, the sweepstakes of the present invention has a one-to-one relationship between the value of the prize amounts and the tickets. One ticket equals one value; however, one entry does not necessarily equal one ticket. A purchaser of the product or service which results in a free entry or even a direct purchase of an entry where legally allowed may receive one ticket for one purchase or he/she may receive multiple tickets for just one entry. There may also be a system where the electronic or mechanical device keeps track of the purchases or entries and distributes one ticket after multiple purchases are made, but the most common distribution method will be one entry will result in one ticket or multiple tickets.

In some examples the ticket system and the entry system of the sweepstakes may be associated with the same device. In some other examples, the entry system and the ticket system may be associated with two separate devices.

In one example embodiment of the disclosed sweepstakes, the purchaser buys a physical product and said product has an identifying code on it (i.e., a bar code). The purchaser then holds the identifying code under an identifying code reader or has it scanned by the identifying code reader by swiping it past the reader. The identifying code reader is attached to a system that either reveals the ticket (or multiple tickets) and its value and/or it actually prints out the ticket in the form of a voucher that is redeemable.

In another example embodiment of the disclosed sweepstakes, the purchaser buys a product or service through a digital or mechanical device and receives one or more entries either in a digital form or a physical form such as a receipt with a specific code. By using a mechanical or electrical device the digital form or the physical form is used to reveal a ticket (or multiple tickets) and the value which is printed or converted into some other digital form that is redeemable.

Further, in another example embodiment of the disclosed sweepstakes, the purchaser buys a digital or virtual product or service through a digital or mechanical device and receives one or more entries either in a digital form or a physical form such as a receipt with a specific code. By using a mechanical or electrical device, the digital form or the physical form is used to reveal a ticket (or multiple tickets) and the value which is printed or converted into some other digital form that is redeemable.

Such sweepstakes systems and methods should be run in strict accordance with any and all applicable state and/or federal laws. For example, in accordance with federal laws concerning promotional sweepstakes, all customers could also receive at least one free opportunity to enter the sweepstakes by sending in a self-addressed, stamped envelope or by simply sending an e-mail to the company. This would mean that each and every time the customer did this they would receive the one free sweepstakes entry which could result in one or more tickets.

Disclosed sweepstakes systems and methods may contain an accounting element that allows direct purchase of additional products or entries from a sweepstakes site. For example, the customer may win $20.00 in the sweepstakes. However, instead of going through steps to convert the prize to cash, the customer may simply select (for example, by clicking a button) an option that allows him/her to buy additional products or entries with that amount of money that the customer just won. In such examples, no monies physically change hands; the exchange is all done within a computing system by converting the prize in the customer's account to credits and additional sweepstakes entries.

Additionally or alternatively, the operator may substitute other physical prizes, products, or services as awards in the sweepstakes game. This can be done by first determining the actual value of each non-cash award and adding it to the total amount in cash offered in the ticket system and allow the system to assign the awards to the tickets or, conversely, determine the same amount and subtract that amount from the total value of the sweepstakes (thus supplying the amount in cash that will be awarded) and then allow the system to assign the awards to the tickets.

In some examples, the sweepstakes may be used on a small scale, for example, from a single location with a few terminals. In some other examples, the sweepstakes may be used on an international platform, incorporating multiple languages, multiple sites and auctions coupled with a very large number of sweepstakes. Such sweepstakes allow for simplicity of use for the purchaser along with the essential accounting measures needed to keep track of potentially millions of customers and their transactions.

Current legal decisions regarding sweepstakes have ruled that any electronic sweepstakes played on machines must meet very limiting and restricting requirements. For example, the North Carolina Supreme Court has taken a dim view on any electronic devices in brick and mortar facilities related to sweepstakes that provide an “entertaining display” in the form of “visual information, capable of being seen by a sweepstakes entrant, that takes the form of actual game play or simulated game play.” (Hest Technologies v. State of North Carolina, No. 169A11-2, Dec. 24, 2012). The North Carolina Supreme Court further concluded that “the restriction imposed here is no greater than necessary because the statute burdens only sweepstakes conducted in a manner that encourages repeated, addictive, gambling-like play through the video display; the statute does not burden or ban any video games outside this context of sweepstakes operations.” Id. As such, operation of electronic machines that conduct sweepstakes through the use of an “entertaining display” may be forbidden under certain state and/or federal laws.

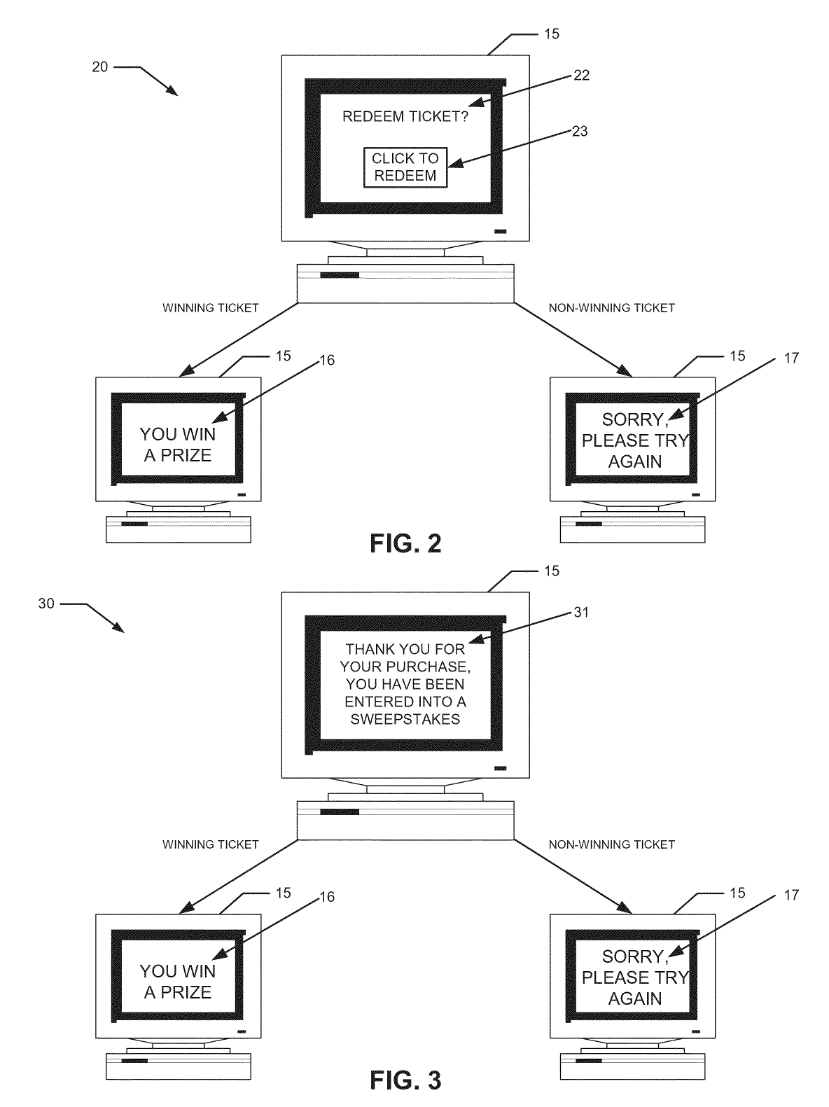

As such, sweepstakes activity conducted on an electronic device in a brick and mortar facility (note, such laws do not apply to computing devices that are owned by private individuals, i.e., personal computers and/or smart phones) must have a great de-emphasis on any activity directly related to the play of the sweepstakes and the presentation of any winning entries. In some legally compliant examples, the method of displaying the play factor and the presentation would be to eliminate any “play” element from the sweepstakes and would have an automatic display to indicate the customer has won or lost. In other words at the point of actual first participation in the sweepstakes, the customer does nothing but view a very basic display that indicates wins and losses (see: FIG. 3). There would be no play and the customer does not have to push or click on any button to find out the results of the sweepstakes. There may not even be any kind of “reveal” display (i.e., clicking a button, see: FIG. 2) where the result is hidden until the customer makes some sort of input. However, such examples may have a “reveal” display, so long as it is not presented in an entertaining, or game-like, manner.

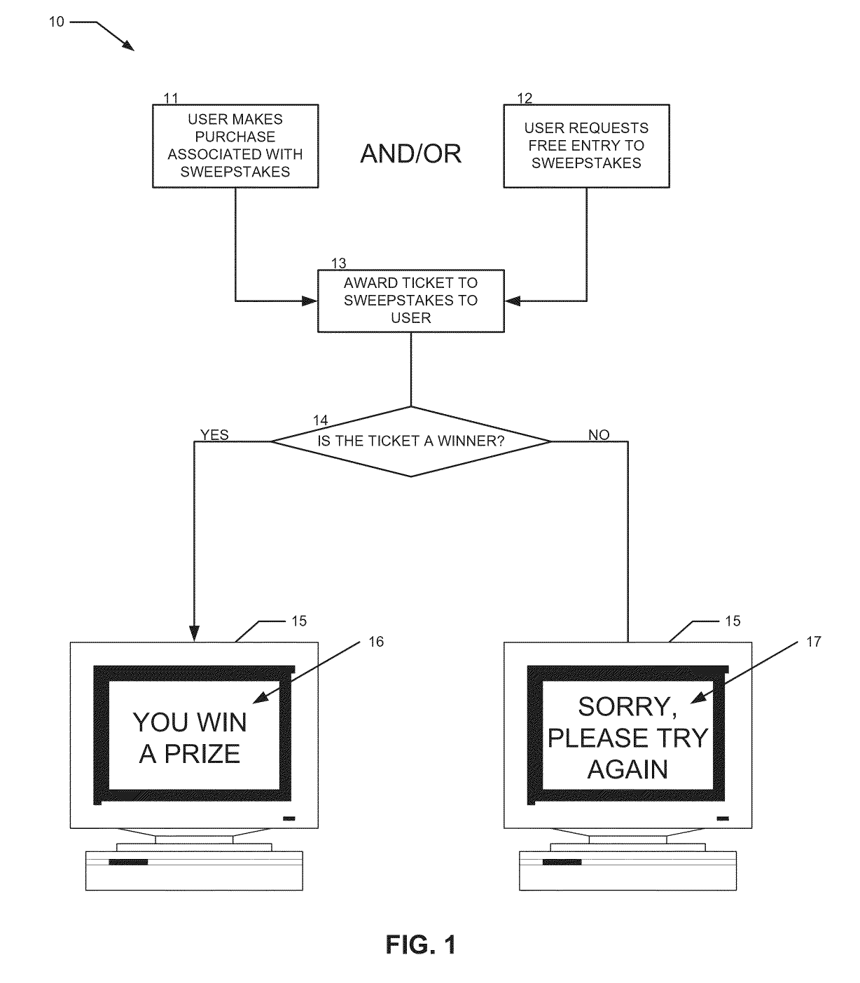

Turning to the figures, FIG. 1 is a flowchart of an example sweepstakes in accordance with the disclosure. The example sweepstakes process 10 begins at either block 11, wherein the user makes a purchase which entitles him/her to an entry ticket in the sweepstakes, and/or the process begins at block 12, wherein the user requests and receives free entry to the sweepstakes, for example, by mailing or emailing the conductor of the sweepstakes a request for entry. At block 13, the user is awarded a ticket (or multiple tickets) to the sweepstakes. At decision 14, the ticket is referenced against a reference data base of tickets controlled by the sweepstakes conductor and a response is generated. If the ticket is a winner, the console 15 displays a winner message 16 and the prize is awarded to the user. If the ticket not a winner, the console 15 displays a losing message 17 and no prize is awarded to the user.

FIG. 2. is an example display sequence wherein the sweepstakes lacks an entertaining display in compliance with federal and/or state laws. A sweepstakes redemption presentation 22 is displayed on the console 15, prompting the user to redeem his/her ticket in the sweepstakes. The redemption presentation 22 contains a button 23. The user clicks, using an onscreen control means, the button 23. Upon clicking the button 23, the process 10 is run and a decision is returned. If the ticket is a winner, the console 15 displays the winning message 16. If the ticket is a loser, the console 15 displays a losing message 17.

FIG. 3. is another example display sequence wherein the sweepstakes lacks an entertaining display in compliance with federal and/or state laws. A sweepstakes redemption presentation 22 is displayed on the console 15, informing the user that he/she has been entered into a sweepstakes. The redemption presentation 31 contains only a message to the user. The user does not interact with the redemption presentation 31, but rather, the process 10 is run on his/her ticket without prompt. If the ticket is a winner, the console 15 displays the winning message 16. If the ticket is a loser, the console 15 displays a losing message 17.

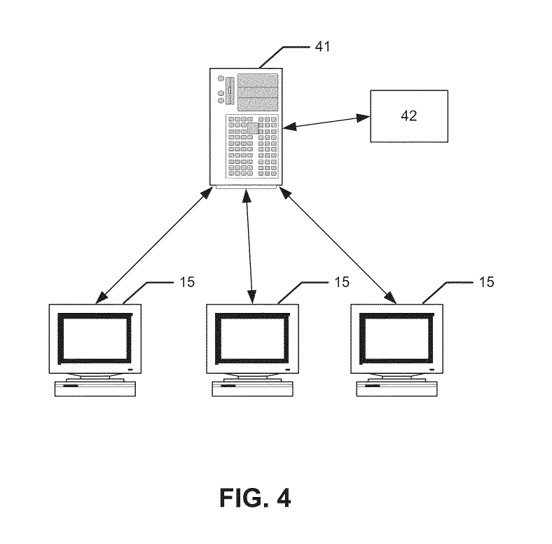

FIG. 4 is a schematic network diagram showing network components and configurations in an embodiment of the invention. The illustrated embodiment of the invention shows a basic model. The basic model includes one location with a local server 41 used for the sweepstakes. Players purchase goods and/or services at the point of sale 42 and play the sweepstakes games to reveal the entry amounts at the consoles 15. The process allows the players to purchase goods or services and have the sweepstakes entries placed in the system. In the system, the user may purchase additional goods or services with winnings from the sweepstakes systems.

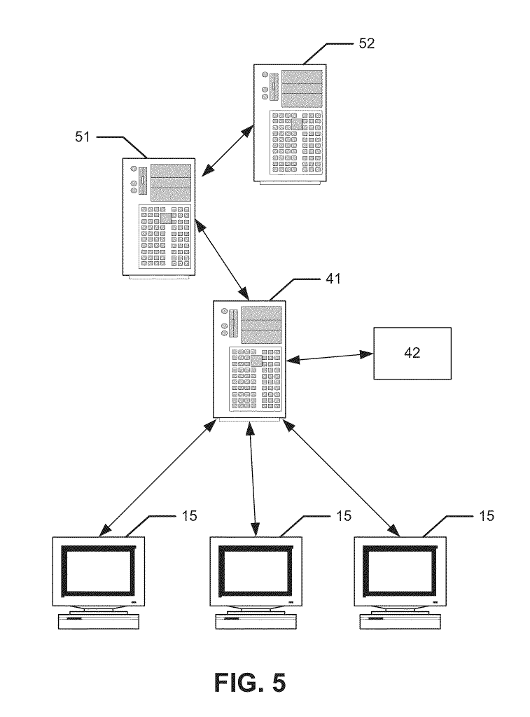

FIG. 5 is a schematic network diagram in an alternative embodiment of the invention. The alternative model includes the features of the network of FIG. 4 but additionally includes an internet data base 51 as well as a marketplace website server 52. In this model when a player purchases goods or services, the internet data base 51 is updated with the goods or services and sweep entries. Further, in this model, the player may conduct purchases on the console 15 or at the marketplace site 52.

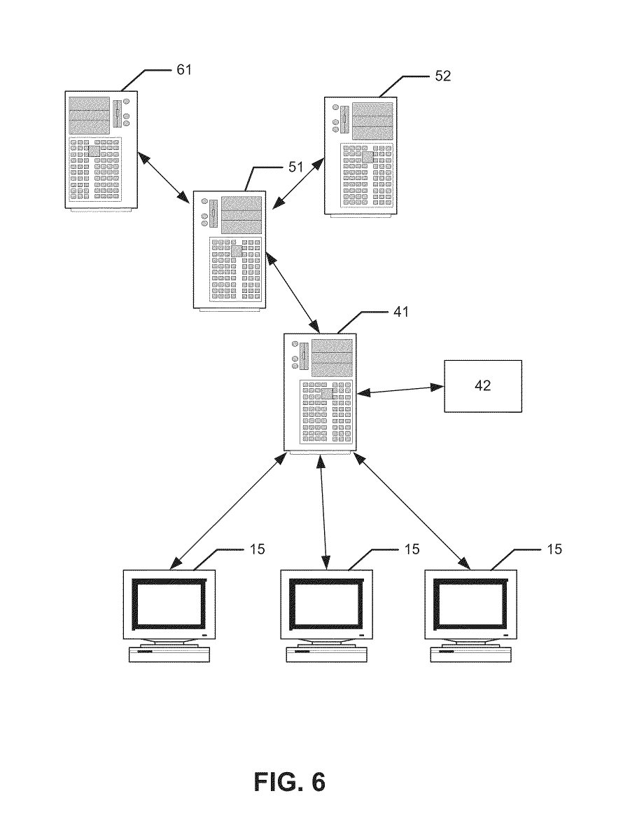

An additional model is shown in the network diagram of FIG. 6. In particular, in addition to the items shown in FIG. 5, the model of FIG. 6 includes a sweepstakes website server 61 to interface to the internet database 51. This model allows players to reveal sweepstakes entries on a website.

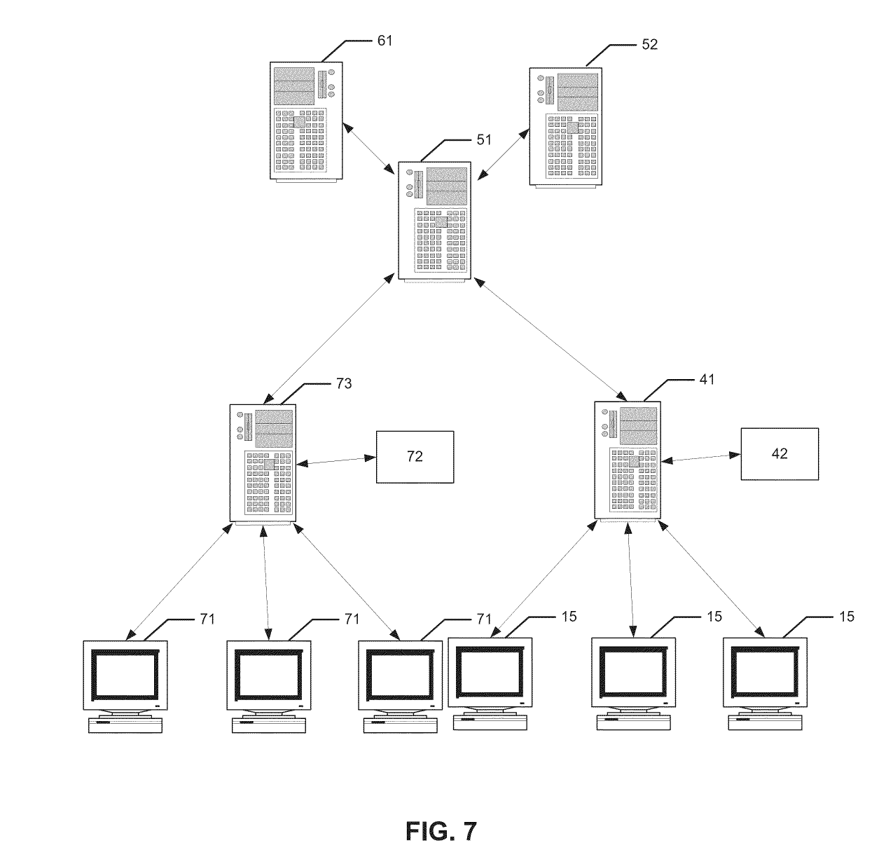

In another embodiment of the invention there are multiple locations connecting to the internet data server, with marketplace site and one sweepstakes site connecting to a central internet data server. This configuration is shown in FIG. 7. In particular, in addition to the elements shown in FIG. 6, the system also includes an additional point of sale 72, local site server 73, and consoles 71.

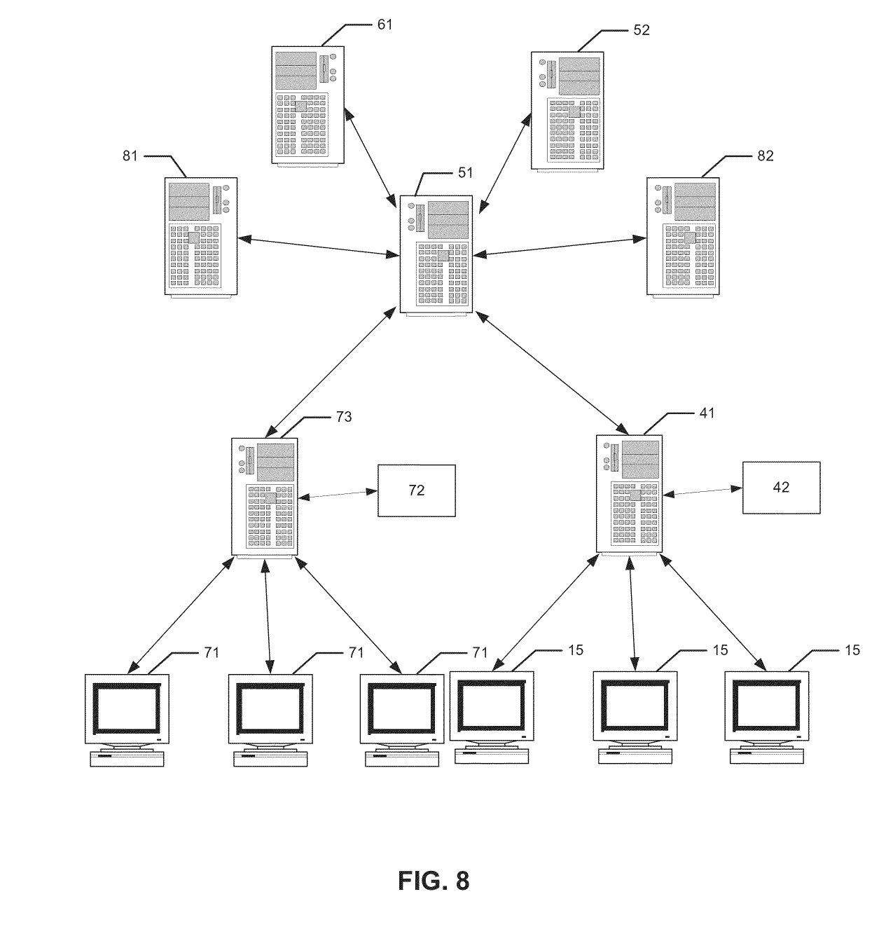

In another model there are multiple locations connecting to an internet data server, with multiple penny auction sites and sweepstakes sites connecting to a central internet data server. This configuration is shown in FIG. 8. In the illustrated embodiment of the invention, in addition to the elements shown in FIG. 7, the system includes an additional marketplace website 81 and an additional sweepstakes website 82.

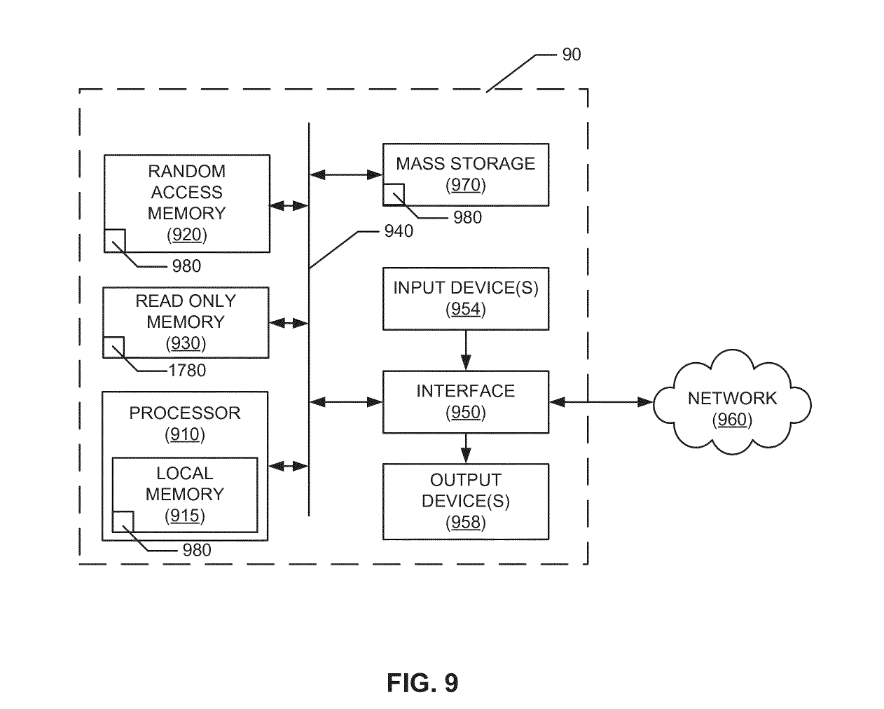

FIG. 9 is a block diagram of an example computing device 900 capable of executing the instructions of FIG. 1 and/or to implement any of the disclosed sweepstakes systems and methods. The computer 900 can be, for example, a server, a personal computer, or any other type of computing device.

The system 900 of the instant example includes a processor 910. For example, the processor 910 can be implemented by one or more microprocessors or controllers from any desired family or manufacturer.

The processor 910 includes a local memory 915 and is in communication with a main memory including a read only memory 930 and a random access memory 920 via a bus 940. The random access memory 920 may be implemented by Synchronous Dynamic Random Access Memory (SDRAM), Dynamic Random Access Memory (DRAM), RAMBUS Dynamic Random Access Memory (RDRM) and/or any other type of random access memory device. The read only memory 930 may be implemented by a hard drive, flash memory and/or any other desired type of memory device.

The computer 900 also includes an interface circuit 950. The interface circuit 930 may be implemented by any type of interface standard, such as an Ethernet interface, a universal serial bus (USB), and/or a PCI express interface.

One or more input devices 954 are connected to the interface circuit 950. The input device(s) 954 permit a user to enter data and commands into the processor 910. The input device(s) can be implemented by, for example, a keyboard, a mouse, a touchscreen, a track-pad, a trackball, isopoint and/or a voice recognition system. The interface 950 may operate in conjunction with, in parallel with, or in place of, any user interface.

One or more output devices 958 are also connected to the interface circuit 950. The output devices 958 can be implemented by, for example, display devices for associated data (e.g., a liquid crystal display, a cathode ray tube display (CRT), etc.).

The interface circuit 950 also includes may include a communication device such as a modem or network interface card to facilitate exchange of data with external computers via a network 960.

The computer 900 also includes one or more mass storage devices 970 for storing software and data. Examples of such mass storage devices 970 include floppy disk drives, hard drive disks, compact disk drives and digital versatile disk (DVD) drives. The coded instructions 980 may be stored in the mass storage device 970, in the random access memory 920, in the read only memory 930, in the local memory 915, and/or on a removable storage medium such as a CD, DVD, and/or flash memory device.

While only certain embodiments have been set forth herein, alternatives and modifications will be apparent from the above description to those of skill in the art. These and other alternatives are considered equivalents and within the spirit and scope of this disclosure and the appended claims.

What is claimed is:

1. A method of providing a sweepstakes associated with a commercial application, the method comprising:
generating a series of sweepstakes tickets, each ticket having a par value and is assigned a prize value, wherein the sum of the par values of the series of sweepstakes tickets is equal to the sum of the prize values of the sweepstakes tickets;
assigning one or more sweepstakes tickets to a user;
determining the value of the one or more sweepstakes tickets assigned to the user; and
notifying, using a display, the user of the value of the one or more sweepstakes tickets assigned to the user.

2. The method of providing a sweepstakes associated with a commercial application of claim 1, wherein notifying the user of the value of the one or more sweepstakes tickets assigned to the user comprises:
displaying a notification that the user is entered into a sweepstakes; and
displaying the value of the one or more sweepstakes tickets on the display, independent of any user interaction.

3. The method of providing a sweepstakes associated with a commercial application of claim 1, wherein notifying the user of the value of the one or more sweepstakes tickets assigned to the user comprises:
displaying a notification that the user is entered into a sweepstakes;
selecting an option to redeem the one or more sweepstakes tickets; and
displaying the value of the one or more sweepstakes tickets on the display.

4. The method of providing a sweepstakes associated with a commercial application of claim 1, wherein the display provides no entertainment value.

5. The method of providing a sweepstakes associated with a commercial application of claim 1, wherein the one or more sweepstakes tickets are assigned to the user when the user has made a purchase.

6. The method of providing a sweepstakes associated with a commercial application of claim 1, wherein the one or more sweepstakes tickets are assigned to the user when the user requests the one or more sweepstakes tickets from a sweepstakes operator.

7. The method of providing a sweepstakes associated with a commercial application of claim 6, wherein the one or more sweepstakes tickets are provided to the user at no cost to the user.

8. The method of providing a sweepstakes associated with a commercial application of claim 1, wherein the user purchases a product associated with the sweepstakes through a website.

9. The method of providing a sweepstakes associated with a commercial application of claim 1, wherein one or more of the prize values are an amount of currency.

10. The method of providing a sweepstakes associated with a commercial application of claim 1, wherein one or more of the prize values have a non-currency value.

11. The method of providing a sweepstakes associated with a commercial application of claim 1, wherein the prize values are values associated with the commercial application.

12. A nontransitory computer readable medium having thereon instructions for performing a method of providing a sweepstakes associated with a commercial application, the instructions comprising:
instructions for generating a series of sweepstakes tickets, each ticket having a par value and is assigned a prize value, wherein the sum of the par values of the series of sweepstakes tickets is equal to the sum of the prize values of the sweepstakes tickets;
instructions for assigning one or more sweepstakes tickets to a user;
instructions for determining the value of the one or more sweepstakes tickets assigned to the user; and
instructions for notifying, using a display, the user of the value of the one or more sweepstakes tickets assigned to the user.

13. A nontransitory computer readable medium having thereon instructions for performing a method of providing a sweepstakes associated with a commercial application of claim 11, wherein notifying the user of the value of the one or more sweepstakes tickets assigned to the user comprises:
instructions for displaying a notification that the user is entered into a sweepstakes; and
instructions for displaying the value of the one or more sweepstakes tickets on the display, independent of any user interaction.

14. A nontransitory computer readable medium having thereon instructions for performing a method of providing a sweepstakes associated with a commercial application of claim 11, wherein notifying the user of the value of the one or more sweepstakes tickets assigned to the user comprises:
instructions for displaying a notification that the user is entered into a sweepstakes;
instructions for selecting an option to redeem the one or more sweepstakes tickets; and
instructions for displaying the value of the one or more sweepstakes tickets on the display.

15. A nontransitory computer readable medium having thereon instructions for performing a method of providing a sweepstakes associated with a commercial application of claim 11, wherein the display provides no entertainment value.

16. A nontransitory computer readable medium having thereon instructions for performing a method of providing a sweepstakes associated with a commercial application of claim 11, wherein the one or more sweepstakes tickets are assigned to the user when the user has made a purchase.

17. A nontransitory computer readable medium having thereon instructions for performing a method of providing a sweepstakes associated with a commercial application of claim 11, wherein the one or more sweepstakes tickets are assigned to the user when the user requests the one or more sweepstakes tickets from a sweepstakes operator.

18. A nontransitory computer readable medium having thereon instructions for performing a method of providing a sweepstakes associated with a commercial application of claim 17, wherein the one or more sweepstakes tickets are provided to the user at no cost to the user.

19. A nontransitory computer readable medium having thereon instructions for performing a method of providing a sweepstakes associated with a commercial application of claim 17, wherein the user purchases a product associated with the sweepstakes through a website.

20. A method of providing a sweepstakes associated with a commercial application, the method comprising:
generating a series of sweepstakes tickets, each ticket having a par value and is assigned a prize value, wherein the sum of the par values of the series of sweepstakes tickets is equal to the sum of the prize values of the sweepstakes tickets;
assigning one or more sweepstakes tickets to a user;
determining the value of the one or more sweepstakes tickets assigned to the user; and
notifying, using a display, the user of the value of the one or more sweepstakes tickets assigned to the user by
displaying a notification that the user is entered into a sweepstakes;
selecting an option to redeem the one or more sweepstakes tickets; and
displaying the value of the one or more sweepstakes tickets on the display.
